(19) United States
(12) Patent Application Publication
(10) Pub. No.: US 2005/0033677 A1
(43) Pub. Date: Feb. 10, 2005

(54) Electronic flex card adjudication system and method

(75) Inventors: Robin Ellen Birdsong, Fort Worth, TX (US); Jeanne Braniff Baker, Fort Worth, TX (US)

Correspondence Address: FROMMER LAWRENCE & HAUG LLP, 10TH FLOOR, 745 FIFTH AVENUE, NEW YORK, NY, 10151, US

(73) Assignee: SMARTFLEX LLC

(21) Appl. No.: 10/940,907

(22) Filed: Sep. 14, 2004

Related U.S. Application Data
(63) Continuation of application No. 09/942,422, filed on Aug. 30, 2001.

(51) Int. Cl. G06F 17/60

(52) U.S. Cl. 705/35; 705/39; 705/40

(57) ABSTRACT

A system and method for processing electronic claims (“e-claims”) for employee benefits program is disclosed. A debit card transaction for an e-claim is automatically detected. By auditing the e-claim and receipts associated with the e-claim, a determination is made as to whether the transaction is an eligible claim that can be reimbursed. If the e-claim is not eligible for payment, the system and method of the present invention automatically tracks and sends notification to the participant to pay back the money. If the participant does not pay back after a number of requests, his debit card is automatically deactivated. Further, as soon as the e-claim is detected, the system and method automatically makes a request to the participant to send in the receipt associated with the e-claim for auditing if the receipt was not received previously. If the receipt is not received within a predetermined amount of time, the participant's debit card for making e-claims is automatically deactivated.

### TECHNICAL FIELD OF THE INVENTION

The present invention is related to an automated system and method for processing claim benefits and more particularly to an electronic flex card adjudication system and method.

### BACKGROUND OF THE INVENTION

The United States Internal Revenue Service (“IRS”) code section 125, a Flexible Spending-Account (“FSA”), and section 132, Transportation Plan, allow a participant and dependents to save a considerable amount of money in taxes. Particularly, the program allows employees or participants to deduct a predetermined amount of money from the participant's before-tax income. This predetermined amount of money is set-aside in the participant's account referred to as a flexible spending account or a flex account. The money then can be used toward paying for expenses incurred for certain eligible items and services specified in the IRS codes. Because the money is deducted from the employee's before-tax income, the amount of tax that is actually paid by the employee is reduced. Further, the employer's FICA payment is reduced.

The eligible expenses include health care, dependent care, transit/van pool, and parking expenses. The pre-tax deductions from the payroll are accounted for in spending accounts, which are divided into sub-categories or sub-accounts. The sub-categories include health care reimbursement (“HCRA”), dependent care reimbursement (“DCRA”), and transportation account. The transportation account is further divided into two sub-accounts: transit/van pool, and parking. The accounting of the funds set aside through payroll reduction into these four separate accounts is separate, and the accounts may not be commingled. E.g., the money is transit/van pool may only be used to pay for the transit/van pool expenses, and may not be used for parking, HCRA, or DCRA expenses.

Further, each category of accounts has separate rules that must be complied with when obtaining the reimbursement. E.g., HCRA account provides pre-tax dollars to pay for healthcare related services and items. Plan Service Providers (“PSP”) are required to provide projected annual contributions per participant. Each participant may not spend more than the projected contribution, but may claim the entire projected amount with initial use or at any time during the plan year. The projected amount may differ from employer to employer. The funds may be lost if a participant does not use them during the planned year.

DCRA account provides pre-tax dollars to pay for dependent care. The DCRA account funds may also be lost if the participant does not use the funds during the planned year.

The transit/van pool account is funded with one pay period or one month's deductions, depending on the participant's choice. This account is funded by payroll deposit and may be allocated as funds are available but not to exceed a monthly maximum of $65, according to the current US regulation, and which amount may change annually. The balance of the account carries forward and may carry to a new plan, year.

The parking account is funded with one pay period or one month's deductions, depending on the participant's choice. This account is funded by payroll deposit and may be allocated as funds are available but not to exceed a monthly maximum of $180 currently, and which amount is expected to change annually. The balance of the account carries forward and may carry to a new plan year.

Once the above accounts are set up, a participant can reclaim the money in the accounts by first incurring the eligible expenses, paying for the expense out of the participant's own pocket, and filling out appropriate forms manually, and sending the form with the receipts for the expenses to a PSP. The PSP then reviews the incurred expenses and if they qualify as any one of the eligible spending expenses, the PSP sends a check to the participant or uses direct deposit or other reimbursement method, at the same time deducting the amount from the participant's flex account. This process is shown in FIG. 1.

FIG. 1 shows a flow diagram illustrating a traditional method for claiming reimbursement for the flexible spending expenses. At 102, an employee makes an election to participate in the pre-tax spending benefits program sponsored by the employer. At 104, payroll deductions in an allocated amount specified by the employee and not exceeding the allowable maximum, are made before federal income tax, state income tax (in appropriate states) and social security tax is applied. The deductions are saved into appropriate flex accounts, i.e., HCRA, DCRA, transit/van pool, or parking sub accounts. At 106, the employee seeks services or purchases items. At 108, the employee pays the provider of the services or purchases items with the employee's own after-tax money. At 110, the employee fills out a form for reimbursement and sends the form with receipts to a plan service provider.

At 112, the plan service provider (“PSP”) reviews the claim for reimbursement for services or purchase item paid. The PSP determines from the receipt, e.g., whether the service or purchase item qualifies for reimbursement. The PSP also determines whether this participant's appropriate sub-account has enough available balance to pay for the expenses. At 114, the PSP approves or denies the claim for reimbursement based on the eligibility and amount available in the sub-account. E.g., if the receipt lists a purchase item of toothpaste purchased at a drug store, the item would not qualify for reimbursement. On the other hand, if the receipt lists eyeglasses, the item would qualify in the HCRA account. In this case, if the sub-account shows enough funds, the PSP would reimburse the participant. At 116, the PSP either sends a check, direct deposit or other reimbursement method to reimburse the participant, if approved, or a denial letter, if rejected, to the participant. At 118, the participant receives his reimbursement. At 120, the participant deposits or cashes the reimbursement check.

Because the participants had to first pay out of the participants' own pockets and because of the hassle and inconvenience involved in filling out forms to claim for reimbursements, not many employees participated in the plan.

Accordingly, to avoid initial out-of-pocket expenses and many inconveniences associated with manual filing of claims for the benefit plans, some companies, referred to as transaction service providers (“TSP”), have created a debit card system that directly and electronically takes out the amount of payment from the employee's set aside account, i.e., appropriate sub-accounts, when the employee uses the debit card. In this way, the employee need not first pay out of the employee's own pocket when using the services or purchasing items that qualify for the plan.

For example, an electronic card like a debit card that electronically accesses funds available in flex account are provided to the participants. When a participant uses the debit card, the amount of money is automatically transferred from the plan sponsor's bank account, which reflect the available balance in the participant's flex account into the service or item provider's bank, via the established VISA or Mastercard processing network. Using the cards significantly reduces the paper work involved. Moreover, the participant does not need to pay for the services or item upfront with the participant's own money.

These existing debit card systems, however, do not discriminate among items or services purchased that are eligible for benefits program participation plan and those that are not eligible under the plan. I.e., even if the purchases were made from an eligible vendor, e.g., a pharmacy, not all items purchased or services may be eligible. Pharmacy, e.g., sells prescription drugs that quality for reimbursement under the flexible spending program, and also items, e.g., shampoo, that do not qualify under the plan. The existing debit card systems currently allow a participant to purchase items with the debit card as long as the purchase is made from a qualified vendor. These systems, however, do not review or check whether the individual items purchased qualify under the plan.

Using the accounts for ineligible items means that the employee and the employer are not complying with the law, i.e., the IRS codes and regulations. Such uses may forfeit the company's as well as the employee's access to such programs, resulting in a great amount of loss, and may result in the employer and the employee being penalized for not complying with the IRS codes.

Moreover, for this reason, many companies are reluctant to use the currently available electronic debit card system, even though it may result in a great deal of convenience and accuracy. Therefore, it is highly desirable to have an electronic debit card system that automatically monitors and adjudicates such electronic claims made through a debit card to ensure that the employees or the participants are using the debit cards for only those items and services which do qualify under such benefits plan.

### SUMMARY OF THE INVENTION

To overcome the shortcomings of various existing programs, the present invention processes plan benefits using debit cards and accurately adjudicates each spending under the plan so that every party involved is in full compliance with the government requirements. The present invention monitors and keeps track of each of the flexible spending and transportation accounts and makes adjudications on all e-claims for these accounts. As a result, the employer and the employee are in full compliance with the IRS code.

In one embodiment, the method of the present invention automatically detects an electronic claim (“e-claim”) made by a participant. A receipt received for the e-claim is used to audit the e-claim to determine whether the e-claim is an eligible claim. If the e-claim is not an eligible e-claim, a reason code is assigned to the e-claim. A follow-up action associated with the reason code is then automatically triggered. Such actions include sending a letter or e-mail to the participant informing the person that a payment for a claim that is not eligible under the benefits plan has been made. The notification also requests a repayment of the claimed amount back to the person's account. If the repayment is not made, e.g., within a predetermined amount of time, the participant's debit card may be automatically deactivated.

In one embodiment, if the participant pays back the amount after the participant's debit card was deactivated, the participant's debit card may be reactivated. In one embodiment, the notification may be an electronic “e-mail”, and may also include a hyperlink through which the participant may make an electronic payment to pay back the money that was used for purchasing the ineligible item or service.

If the e-claim is determined to be eligible, the e-claim is approved, and an appropriate code is assigned. These codes may be used to audit various data concerning the participant's claim activities or generate various history reports.

In one embodiment, the e-claim data is received in real time, such that claims made by a participant is reviewed, and processed as soon as the claim is made. In another embodiment, the e-claim data may be batch data, e.g., a day's worth of e-claim data downloaded from a transaction service provider's database.

In one embodiment, the e-claim may be detected during a settlement reconciliation process. For example, if an employee's account balance is less than what it should be, the method and system of the present invention makes inquiries concerning the deductions and reconciles an e-claim transaction with the deductions in the account balance. An adjudication process described Above is then performed for this reconciled e-claim.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 shows a flow diagram illustrating a traditional method for claiming reimbursement for the flexible and transportation spending expenses;

FIG. 2 is a flow diagram that illustrates the use of the electronic flex card by a participant in one embodiment of the present invention;

FIG. 3 is a flow diagram illustrating the processing of the e-claims in one embodiment of the present invention;

FIG. 4 is a flow diagram illustrating the adjudication process in one embodiment of the present invention;

FIG. 6 is a diagram that illustrates the integration of the e-claims with the manual claims in one embodiment of the present invention; and

FIG. 7 is a flow diagram illustrating card administration in one embodiment of the invention.

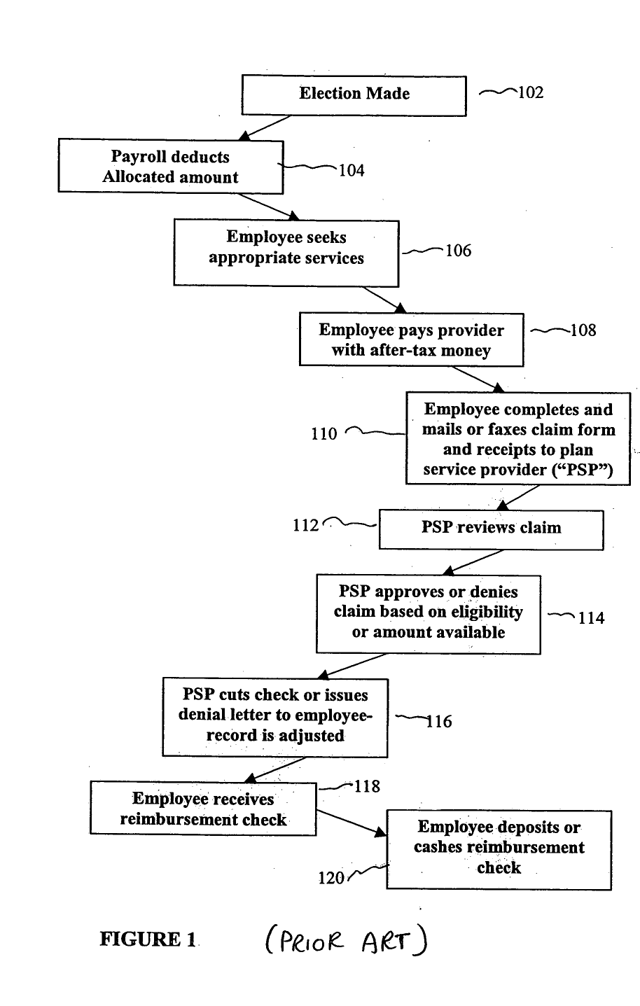

### DETAILED DESCRIPTION OF THE PREFERRED EMBODIMENT OF THE INVENTION

The present application is directed to an electronic flexcard, or debit card, administration system (“EFA”) that processes flexible and transportation benefits programs electronically in real time. The system and method of the present invention provides flexcard to each participant and dependents. Participants may then use the card in a similar manner as a debit card.

Transactions that made through the flexcard are referred to as electronic claims (“e-claim(s)”). These transactions or e-claims are processed and reviewed to determine whether they contain valid claims. A determination is also made to ensure that there are sufficient amount of funds available in this participant's flex account. This method allows the participant to pay for the eligible flex benefit expenses directly from his set aside account without having to wait for reimbursement and with going through a lot of paper work.

E.g., when an employee decides to participate or enroll in the flexible spending or transportation program, the employee, i.e., the participant automatically receives the debit card. The employee then signs the card before using it. By signing the debit card once the participant receives the card, the participant is agreeing to the terms of the debit card administration system, acknowledging that the funds are authorized only for the payment of qualified expenses, certifying that the funds have not and will not be reimbursed under any other plan coverage, and agreeing that the participant will submit any required documentation to the plan administrator.

As soon as the participant's account is set up with the employer for eligible expenses and the before-tax deductions begin, the participant may begin using the card. The debit card works the following way. The participant purchases items or services that are eligible for the flexible spending program. To pay for the items or services, the participant uses the debit card like any other debit or credit card. The participant sends the receipt to a plan service provider.

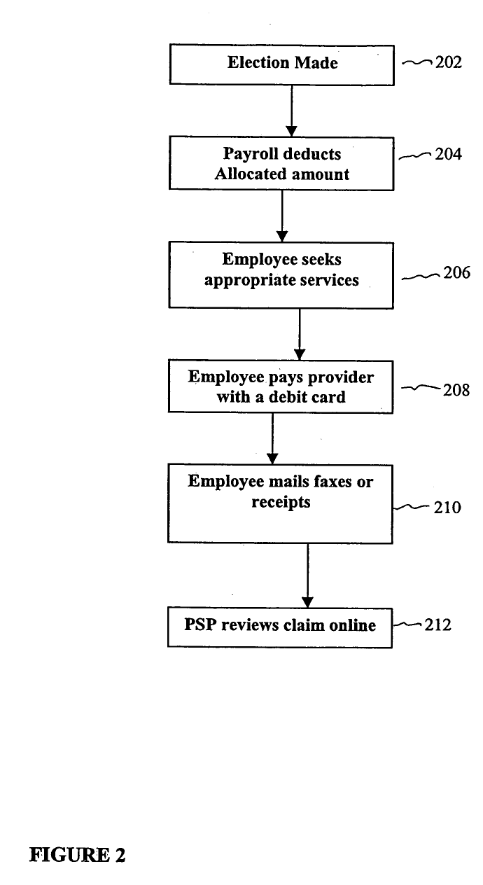

FIG. 2 is a flow diagram that illustrates the use of the electronic flex card by a participant in one embodiment of the present invention. At 202, an employee makes an election to participate in the flex and transportation benefits plan. The employee is referred to as a participant. At 204, an amount specified by the participant is deducted from the participant's payroll and is set-aside in the participant's flex account. At 206, employee seeks appropriate services, e.g., purchases eyeglasses, or incurs parking fees. At 208, the employee pays provider for the expenses with the flex card issued to the participant. At this point, a transaction or an e-claim has occurred. At 210, the participant sends in by mail, e-mail, fax, etc., the receipt that itemizes the expenses incurred. At 212, the EFA system reviews the expenses on line by auditing the transaction or the e-claim. The EFA system's review includes the adjudication process, which will be described in more detail below.

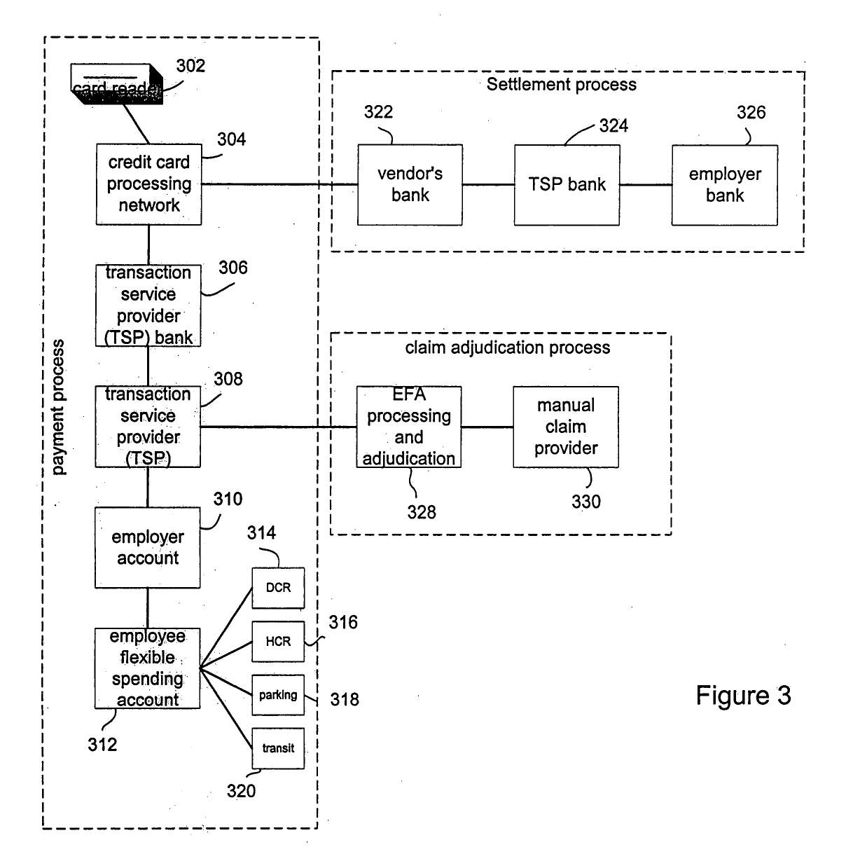

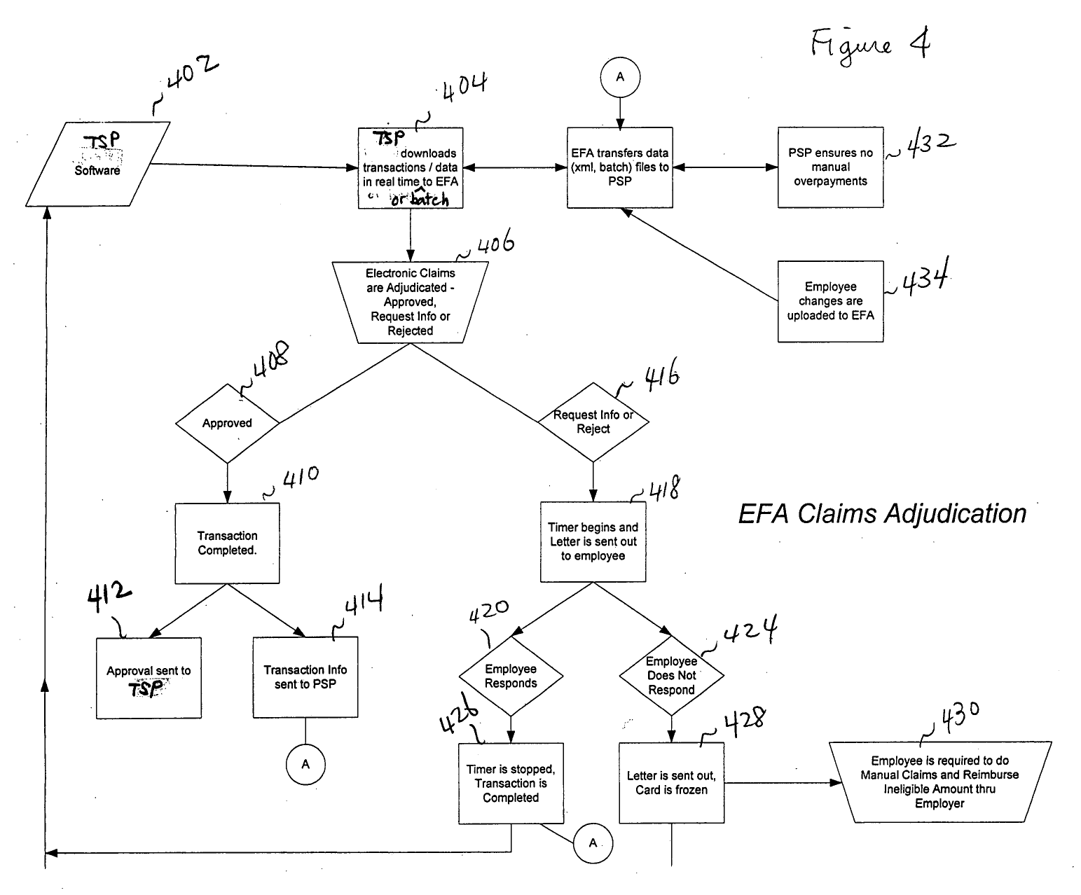

FIG. 3 is a flow diagram illustrating the processing of the e-claims in one embodiment of the present invention. At 302, a participant uses the flex card, i.e., the debit card, by e.g., swiping the card at an eligible vendor. An eligible vendor, e.g., may be the doctor's office, eyeglass center, parking lot, or pharmacy. In one embodiment, the debit card is provided by a transaction service provider (“TSP”) who has agreements with banks and credit or debit card processing companies. Thus, at 304, the debit card transaction is notified to a debit card processing network. At 306, the bank that has agreed to process the debit card is also notified. At 308, the transaction performed with the debit card is then transmitted to a transaction service provider. At 308, the transaction service provider pre-authorizes the transaction by checking the card's status and the account balance associated with the appropriate sub-account 314, 316, 318, 320 of the card for that merchant category code (“MCC”) at 310 and 312. At 308, if the MCC code and the amount are approved, then the transaction or e-claim is pre-authorized. If the transaction is pre-authorized, at 310, a hold is put on the money at the transaction service provider. If not pre-authorized, then transaction is declined. The EFA receives the pre-authorization notification from the TSP.

The EFA of the present invention may receive different types of transactions for EFA'S processing. Transaction types include pre-authorizations, forced-posts, settlements, refunds, and manual transactions. The following information is typically supplied to process the transactions: account balance, account number, account type, approval code, flexcard number, effective data, MCCSIC code, merchant ID, merchant type, message type, original transaction date, original settle date, pending hold balance, start date, end date, pre-auth hold balance, transaction amount, transaction status, transaction type, transaction code, terminal city, terminal state, TSP identifier, TSP settle number, TSP settle date.

As described above, pre-authorization transaction is a transaction that is sent by the merchant to authorize the transaction at the same time the pre-authorization amount is placed on hold. Pre-authorizations are not settled. Forced-post transactions are the transactions submitted to force a posting where no previous pre-authorization was supplied. A settlement occurs when a transaction completes and the pre-authorization is replaced with the settled transaction. Force-posts are settled as posted. As a consequence, account funds are deducted from the balance.

For pre-authorization transactions that the EFA has not received a matching settlement transaction after 30 days, the pre-authorization is released. If a pre-authorized amount is released, that amount is placed back into the participant's account.

Other transaction types include purchases (typically pre-authorized), refunds, and returns. Purchase transactions are the transactions submitted to both request and validate a purchase.

Purchases may be declined. Purchases are settled. Account funds are deducted from the balance. Refund transactions are the transactions submitted to request a refund of previous purchases or force-post. Refunds may be declined. Refunds are settled. These funds are then credited to the balance.

Returns or ineligible spending payment may be made for items purchased. These transactions are associated to the original transaction by a transaction identifier. Should participant return items to a merchant, the transaction credits back to the account from which it was taken. The transaction details are then reported back to the PSP by, e.g., an XML document. The transaction details may include: transaction identifier, account type, flexcard number, administrative fee, transaction date, MCC code, merchant name, response code, settlement date, transaction amount, transaction code, and transaction status.

When a participant is notified to reimburse their account, e.g., because the item purchased with the debit card is not an eligible flex spending or transportation item, the participant may do so by logging on a provided website and paying by credit card or check. The participant may also mail or wire ineligible spending reimbursement funds to the PSP. EFA generates an XML or batch document when payments are made and supplied to the PSP. To process the ineligible spending payment transaction, the following information is supplied to the EFA: original transaction identifier, original transaction settle date, return/credit amount, participant social security number, transaction identifier, transaction code, transaction fee amount, account type, and transaction type.

Referring back to FIG. 3, if the transaction is pre-authorized, the processing continues to the settlement process. At 322, the vendor's bank requests a payment. At 326, the employer or the card sponsors having access to the sponsoring bank account is notified that the amount of money is needed for settlement to be made typically within 24-48 hours. The employer may be notified by the EFA which processed the pre-authorization and force post transactions. The employer provides funds or makes funds available for settlement. At 322, the vendor receives payments for provided services or items. At 328, the processing continues to the EFA system where the e-claims are adjudicated. At 330, a plan service provider that is processing manual claims notify the EFA system of any manual claim payments that have been made. This way, EFA keeps track of both e-claim and manual claims in order to adjust balances.

Briefly, a settlement is when the transaction is to be paid by a bank. This usually takes between 24 and 48 hours. Settlement occurs when force-post and purchase (pre-authorization) transactions are sent by the processing bank for settlement to the plan sponsor bank. These transactions have been received by EFA. The funds are deducted from the plan sponsor or PSP account to fund the transaction amount. If refund transaction has occurred, these transaction amounts are credited to the plan sponsor or PSP account.

Following a force post or pre-authorization, a request for funds is generated by the EFA system. This request for funds may be e-mailed to the PSP or plan sponsor on such timetable as established, which may include each morning for the prior 24 hour period totals. The request for funds may include: transaction date, social security number, first name, last name, fee, amount, number of transactions, number of manual transactions, total purchase amount, total fees, and total.

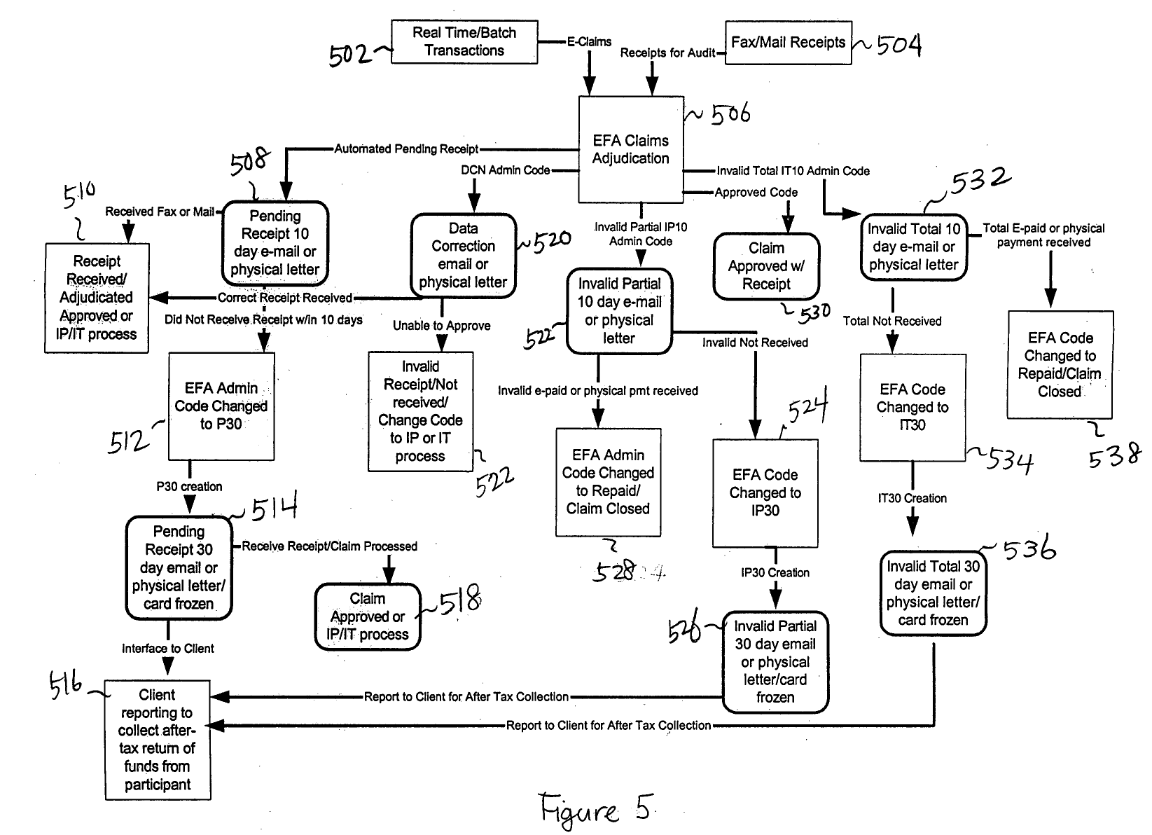

FIG. 4 is a flow diagram illustrating the e-claim adjudication process in one embodiment of the present invention. At 404, e-claim data is downloaded from the transaction service provider 402. The data may be downloaded in real time, i.e., when the transaction occurs. E.g., the real time data may be transferred in an extensible markup language (“XML”) format. The data may also be downloaded in a batch mode, e.g., a day's worth of data at the end of the day. From the e-claim data received, the EFA may detect an occurrence of transaction for an e-claim. The EFA also may detect an e-claim when a receipt of a transaction is received without a matching e-claim. In this case, the EFA monitors any incoming e-claim data to match to the receipt.

At 406, the e-claim is adjudicated, e.g., by approving, requesting more information, or rejecting the e-claim. To approve the e-claim, it is determined, e.g., by comparing the receipt, whether the e-claim was used for one of the eligible services or purchases. If the e-claim was used for an eligible service or purchase, at 408, the e-claim is approved. At 410, the transaction is completed, and at 412, an appropriate approval code is sent to the transaction service provider. At 414, the transaction information is also sent to the plan service provider The span service provider, e.g., processes the flex and transportation benefits claims that are filed manually. In this way, both e-claim and manual claims are integrated at both the EFA and the PSP to provide an up-to-date account balance associated with participant and up-to-date transaction information associated with this participant.

At 416, EFA determines whether a receipt that matches this transaction has been received. If not, a request for the receipt is automatically sent to the participant for the request. The request may be made via an e-mail, a letter, or any other means. The EFA may trigger an automatic sending of the request for the receipt periodically until the receipt is received or for a predetermined number of times. In the case that the participant does not send in the receipt, the e-claim may be adjudicated as rejected.

At 416, EFA may reject the e-claim if the receipt shows ineligible items purchased or serviced. Further, if more detailed information is required, e.g., because the receipt does not distinguish the items purchased or service, a request for information is sent the participant at 418. At the time the request is sent, a timer may be set to begin counting the time that the participants respond by. At 420, if the employee responds within a predetermined amount of time, and if it is determined that all items purchased or serviced in the transaction are eligible items, at 426, the timer stops, an appropriate approval code is set, and transaction is completed.

At 424, if the participant does not respond, at 428, a notification letter is sent to the participant, and the flex card is deactivated. When the flex card is deactivated, the participant may no longer use the flex card to claim for the benefits. Instead, the participant is required to file for the benefits claims manually as well as repaying the e-claim deduction amount.

Similarly, for e-claims that are rejected, the participant is sent a notification that the e-claim is not valid, and the participant must pay back the amount of money deducted from the participant's flex benefit account to pay for the e—claim expense. If the participant does not pay the money back, the flex card is deactivated automatically. Further the participant's employer may be notified along with additional information so that the employer may take its own actions in recovering the amount of payment, e.g., by automatically deducting the amount from the participant's paycheck.

In the notification sent to the participant, the EFA may provide an automated way for the participant to pay back the amount. For example, if the notification is sent by an e-mail, the e-mail may include a hyperlink to a plan processing web site that accepts credit cards payments. The participant may then pay back by using the participant's own credit card.

At 432, all manual payments made by a plan service provider is sent to the EFA so that EFA can keep track of the up-to-date information and accurate account balance. At 434, changes in employee or participant data are also sent to the EFA for the most updated information to be kept by the EFA.

FIG. 5 is a flow diagram illustrating detailed e-claim adjudication process in one embodiment of the present invention. At 502, e-claim data, i.e., transaction data, are received either in batch mode or in real time, from the TSP. At 504, receipts used for the e-claim transactions are received. The receipts may be received by any method, e.g., e-mail, fax, mail. The receipts include detailed transactions for purchases or services. At 506, EFA adjudication process begins. EFA assigns appropriate administration (“admin”) codes to each transaction. E.g., EFA generates participant transaction status letters automatically at 10 and 30 days after the occurrence of a; transaction, i.e., an e-claim, if electronic adjudication has not occurred because the participant did not send in required receipts.

At 508, if an e-claim occurred 10'days ago and if EFA did not receive a receipt for the e-claim, a P10 code is assigned to the e-claim. The P10 code automatically triggers contacting the participant. E.g., e-mail may be sent out or a 10 day pending letter is generated and sent. At 510, if the participant sends the receipt, the process continues to either approve or deny the e-claim.

At 512, if 30 days have passed since the e-claim was detected, and if the participant still did not send the receipt, the code is changed to P30. P30 code automatically triggers sending out 30 day pending notification to the participant at 514. At the same time, the debit card is deactivated such the participant may no longer use the debit card for flexible spending and transportation expenses. At 516, the EFA also may notify the employer of the participant's status and failure to provide appropriate receipts. At 518, if the participant, thereafter, send a receipt in, the EFA proceeds with the adjudication process.

At 520, if the e-claim's matching receipt was received, but the receipt does not have enough information to determine whether the purchased service or item qualified under the benefits plan, EFA sets the admin code to DCN10, i.e., data correction notice. Setting the admin code to DCN10 automatically triggers a DCN letter to be generated. The letter informs the participant, e.g., that the information supplied is incorrect and the participant has ten days to send correcting information. The letter is sent to the participant by email or any known method. At 522, an indication is set that EFA is unable to proceed with the approval if receipt is not received. If the receipt is received, EFA presumes its adjudication process.

If a receipt is not received within 10 days of sending the DCN letter, the admin code automatically changes to DCN30, triggering a DCN 30 day letter to be sent to the participant. The letters inform the participant that more information is required to process the e-claims. At the same time the DCN30 day letter is sent, the EFA may select to deactivate the card. Upon receiving the required information, EFA may reactivate the card.

At 522, EFA assigns IP (invalid partial) admin code to the e-claim, if from reviewing the receipt and any other information, it is determined that part of the spending was for the qualified items or services and part of the spending was not for the qualified items or services. In this case, the e-claim adjudicated is partially approved and partially denied. For the denied portion, a 10 day invalid partial letter is sent to the participant requesting the participant to pay back the amount used for the non-qualified items or services. The admin codes changes to IP30 at 524 if the payment is not received within the required 10 days of the request. At 526, the IP30 letter is generated, further requiring the reimbursement of non-eligible funds and the card is deactivated. EFA may also notify the employer as shown at 516. At 528, if a payment is received, the admin code is changed to repaid/claim closed and the transaction is completed.

At 530, if EFA matches an e-claim with a receipt and the receipt indicates that all items or services purchased using the debit card were qualified items or services, the admin code is assigned to approved. The transaction then is complete.

At 532, if the e-claim has a matching receipt, but the receipt indicates that none of the items or services purchased using the debit card qualify under the benefits plan, the e-claim is assigned an admin code of IT10. Assigning the code to IT10 automatically triggers a 10 day letter to be generated and sent to the participant. The letter requests that the participant pay back the total amount, money to be funded back to the participant's appropriate flex account.

At 534, if the money is not paid back within the required 10 days, the admin code automatically changes to IT30. At 536, IT30 code automatically triggers a 30 day invalid total letter to be generated and sent to the participant, further requiring repayment of total dis-allowed amounts and notifying deactivation of the card. At the same time, the participant's debit card may be deactivated EFA may also notify the employer as shown at 516, as the funds are required to be repaid.

When an IT10 or IT30 letter is sent, the EFA may embed a hyperlink in the e-mail letter. The hyperlink allows the participant to click on the link and go directly to an Internet site where an electronic payment may be made for paying the amount back. The participant would supply a credit card number, e.g., on the page of the Internet site, for paying the amount to be put back into the flex account. At 538, if a payment is received for the invalid total, the admin code changes to repaid/claim closed, and the transaction is complete.

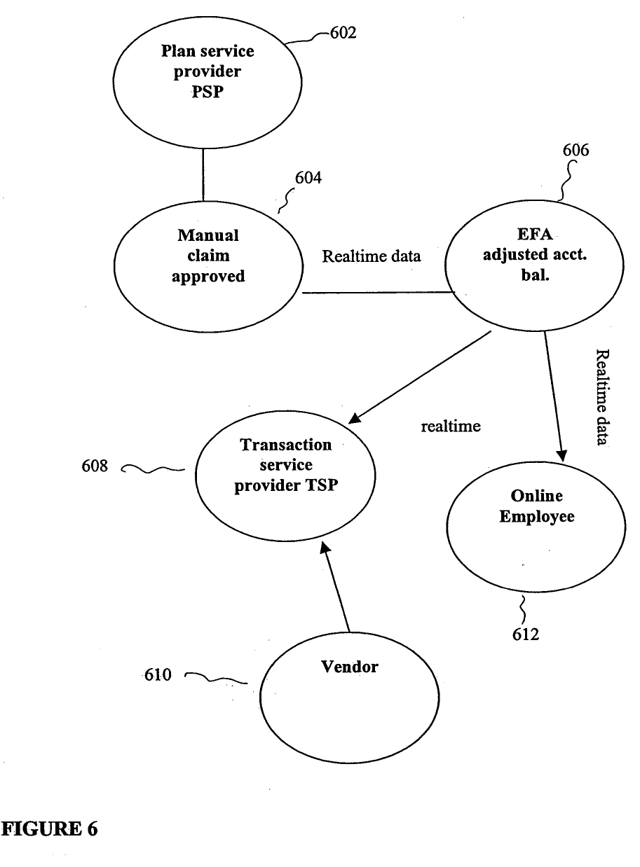

FIG. 6 is a diagram that illustrates the integration of the e-claims with the manual claims in one embodiment of the present invention. At 602, a plan service provider (“PSP”) receives a manual claim and decides whether to pay the reimbursement for the claim. At 604, the manual claim is approved and a payment is made to the participant. At 606, the PSP notifies the EFA in real time or via batch file, that an amount has been paid to the participant, and therefore, the amount has been deducted from the appropriate flex account. The EFA notifies the TSP of the manual payment made, so that TSP is also aware of the current-total-remaining in the flex account. At 608, when a vendor at 610, requests an e-claim, the TSP at 608 will be able to process the e-claim with an up-to-date balance of the flex account. At 612, an employee may check the status of the employee's flex account that is updated with both the e-claims and manual claims.

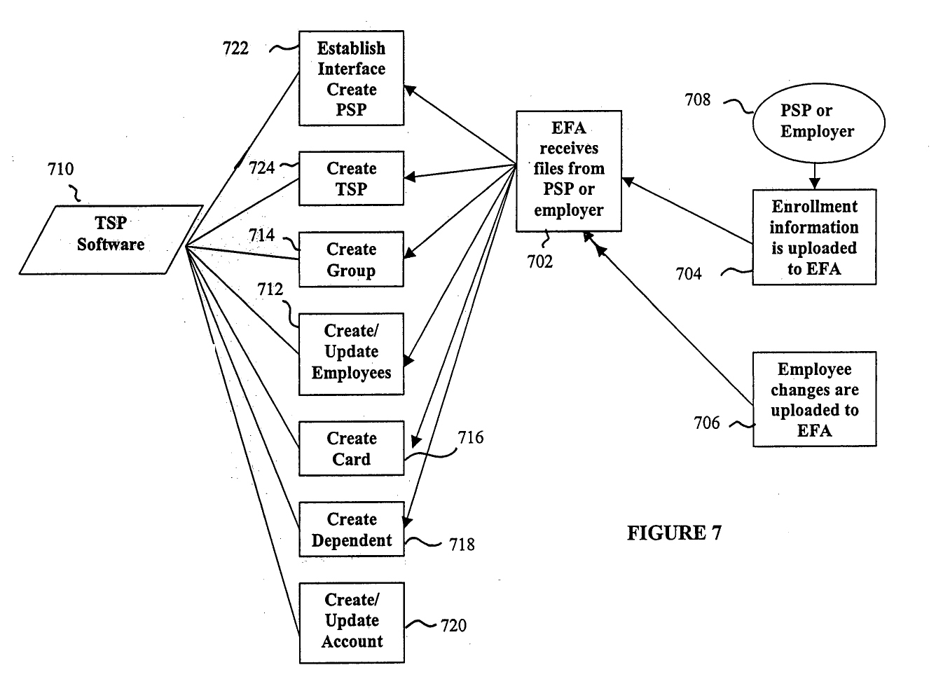

FIG. 7 is a flow diagram illustrating card administration in one embodiment of the invention. EFA provides administration tools that allow PSP's, employers and participants to access and administer the accounts. At 722, a new PSP account may be setup. The PSP initial load may be by an XML document, batch file, or may be entered via the Internet through a PSP load screen. The following information is used to setup a PSP account: PSP name, PSP address, PSP city, PSP state, PSP zip, PSP phone, PSP administrative fee amount, PSP contact first name, PSP contact middle initial, PSP contact last name, PSP e-mail, PSP tax identifier, PSP password, PSP card fee amount, PSP transaction fee amount, PSP deposit amount. A new PSP may be set up, e.g., if an employer uses a new plan service provider (PSP) to manage its flex accounts.

A new employer account may also be set up in the EFA for any new employers participating in the electronic flex card administration system of the present invention. The employer data may be loaded via an XML document, batch file or may be entered via the Internet interface. The following employer or company information is used to set up the employer account: name, address, city, state, zip, phone, e-mail, fax, contact name, tax identifier, group deposit amount, transaction fee amount, password, ER/EE fee pay, plan year start, plan year end, HCRA account, DCRA account, transportation commuter account, transportation parking account, payroll/calendar-information, card fee amount. EFA send this new information to the TSP also, e.g., as an XML document.

The EFA at 702 receives all new enrollments at 704 as well as any updates, to employee data at 706 from the plan service provider or the employer at 708. The EFA at 702 then establishes interfaces with the transaction service provider at 710 to manage the new enrolled employee. E.g., at 712, create employee interface is sent to the TSP to set up an account for the employee and to create a debit card for the employee.

For a new employee the following data are used: PSP ID, employer tax ID, start date, end date, social security number, date of birth, name, address, city, state, zip, phone, e-mail, HCRA account information, DCRA account information, transportation parking account information, transportation commuter account information, payroll/calendar information. Dependent data information for additional dependents enrolled are also entered into the EFA as shown at 718. This new information is sent to the TSP, e.g., as an XML document.

Similarly, at 724, a new TSP may be created. At 714, a new group may be created. At 716, a create card transaction is sent to the TSP 710 so that the TSP 710 may issue a new card. At 720, new accounts may be created and updated similarly.

The EFA in one embodiment of the present invention includes many management and monitoring functionalities. These management functionalities include ability to report on various status of the e-claims per employee, employer, sub-accounts, etc. Moreover, the EFA includes a currency conversion capability, e.g., for when an employee spends the flex account money via the debit card in another country. In this case, the balance in the employee's account is automatically and accurately adjusted even when foreign currencies have been used.

Another management functionality includes ability to monitor logons, adjudications, and various on-line queries by participants or employers. Further, the EFA allows the different sub-accounts to have a different plan year.

The EFA in one embodiment of the present invention includes reporting capabilities enabling the participant, the employer and any other administrative personnel having access to the data to view the history of various data concerning the participant's e-claims and flex card usage. Table 1 is a sample list of the reports generated by the EFA.

TABLE 1

| Current | |
|---|---|
| Report Titles | Report description |
| Active Account | shows total cards per account, shows total |
| List | dependents cards. |
| Claims Detail | ability to select by transaction status such |
| | as unapproved, pending, approved, denied, |
| | etc. |
| | ability to report final total amount of |
| | money for all accounts per participiant. |
| | ability to report by date ranges. |
| | ability to run with or without fees. |
| | ability to report without merchant |
| | information for confidentiality purposes. |
| | ability to report reasons for denials. |
| Bank | ability to run for multiple Groups-for |
| Transaction | those sharing bank accounts. |
| Reconciliation | |
| Daily | ability to breakdown by account, with |
| Settlement | ability to combine multiple groups. |
| Reconciliation | ability to breakdown by social security. |
| | name, amount, fee, total |
| | ability to breakdown by total per account/ |
| | total per client. |
| Disbursement | option to show without vendor name for |
| Detail | confidentiality issues. |
| | ability oto add parameter by enrollee (detail |
| | for Customer Servie usage.) |
| Enrollee List | ability to chose a by card status. |
| | can list everyone who has had a card in that |
| | plan year. |
| Enrollee | negative balances to result from Manual |
| Negative | entries so balance will match PSP. |
| Disburseable | |
| Balances | |
| Enrollee | ability to report account history to |
| Statement | participant, send enrollment verification |
| | statements |
| | report on additional details. |
| | ability to include comment section for |
| | adding messages. |
| Enrollee | This is an accounting statement, summarizing |
| Ledger Summary | the funding transactions by account by |
| | participant |
| Enrollee Year- | ability to insert group Logo/name. |
| End Statement | ability to breakdown deductions by manul or |
| | electronic claims. |
| | ability to add comment section, which can be |
| | by employee or group. |
| Current | ability to report on currently available |
| Report Titles | reports. |
| Lost/Stolen | ability to report a list of all additional |
| or Replacement | cards by third party administration or plan |
| Cards | service provider for the plan year. |
| Plan Service | ability to list by Group, Employee, Account |
| Provider | Type |
| (“PSP”) Manual | |
| Transactions | |
| PSP Settlement | ability to add by Group or multiple groups. |
| Much more | ability to report on Averages, percentages, |
| Group Level | totals by Account Type, Group, PSP: |
| Reporting for | Averages of usage (# of transactions, |
| evaluating, | Dollar Volume) |
| pricing, | Percentages by Account type by Group, TPA. |
| projecting | Percentage of used cards versus unused |
| usage | cards. |
| | Average amount in currency or transactions |
| | and currency volume by Account type, Group, |
| | PSP. |
| | Compare percentages and totals from Group |
| | to Group or Group to Total PSP activity. |
| | Percentage of approved claims versus |
| | ineligible claims. |
| | Monthly progression on transaction volume |
| | (summary and graph). |
| | Electronic versus Manual. |

The reports may be run on selected number of fields, e.g., by dates, groups, etc.

The EFA of the present invention provides Internet interface as well as other remote access, where various persons having access, including participants and employer to log on to the EFA and generate reports, view a current status of the participant's account, or view various information. E.g., a participant-may log on to the system and view why a transaction is being denied, current account balance on various accounts associated with participants card, current census information to check for accuracy of information, e.g., address, e-mail, phone number. Employee may also view current usage and statements.

The following transaction information are some of the information that may be viewed by PSP's, employers, and participants according to their system privileges: name, social security number, PSP ID, employer tax ID, account balance, account number, account type, approval code, flex card number, administrative fee, effective date, last update, MCC SIC, merchant ID merchant name, merchant type, original transaction date, original settle date, original settle number, pending hold balance, plan ID, plan start, plan end, transaction flags, pre-authorization hold balance, TSP settle date, TSP settle number, transaction amount, transaction status, transaction type, transaction code, DCN code, user ID. The information is not limited to only this list.

Using the EFA, PSP's may access or update many of the above transaction information. Moreover, in one embodiment, the EFA allows employers and PSP's to deactivate or reactivate the participants' accounts remotely, e.g., via the Internet. Further, a participant may request a replacement-card, report a stolen or lost card, e.g., via the Internet.

The EFA in the present invention ensure 100% compliance with the current IRS requirements. The EFA may be programmed in any known computer language, including Visual Basic, and run on any platform, e.g., Windows® operating system.

While the invention has been particularly shown and described with respect to particular embodiments thereof, it will be understood by those skilled in the art that the foregoing and other changes in form and details may be made therein without departing from the spirit and scope of the invention.

1. A method of adjudicating an e-claim made through electronic debit card spending; comprising:
automatically detecting an e-claim made by a participant;
receiving a receipt for the e-claim;
auditing the e-claim with the receipt to determine whether the e-claim is an eligible claim;
if the e-claim is not an eligible e-claim,
assigning a reason code to the e-claim;
automatically triggering a follow-up action associated with the reason code to inform the participant of the ineligible e-claim; and
if the e-claim is an eligible claim,
approving the e-claim.

2. The method of claim 1, wherein the automatically triggering a follow-up action includes:
periodically sending one or more notifications to the participant for a predetermined number of times, informing the participant to pay back the amount claimed in the ineligible e-claim; and
if the pay back is not received within a predetermined amount of time, deactivating a debit card that initiated the e-claim.

3. The method of claim 1, wherein the automatically triggering a follow-up action includes:
sending a notification to the participant to pay back the amount claimed in the ineligible e-claim.

4. The method of claim 1, wherein the automatically triggering a follow-up action includes:
automatically deactivating a debit card used in the e-claim.

5. The method of claim 2, wherein the sending a notification includes sending e-mail.

6. The method of claim 1, wherein the automatically detecting includes automatically receiving real time e-claim transaction data.

7. The method of claim 1, wherein the automatically detecting includes receiving batch e-claim data.

8. The method of claim 1, wherein the automatically detecting further includes:
triggering a request to receive a receipt associated with the e-claim from the participant.

9. The method of claim 1, wherein the automatically detecting further includes:
triggering a request to receive a receipt associated with the e-claim if it is determined that the receipt was not received.

10. The method of claim 1, wherein the automatically detecting further includes:
periodically triggering a request to receive a receipt associated with the e-claim from the participant.

11. The method of claim 1, wherein the automatically detecting further includes:
triggering a request to receive a receipt associated with the e-claim from the participant; and
if the receipt is not received after a predetermined number of requests has been made, automatically deactivating a debit card used for the e-claim.

12. The method of claim 1, wherein the automatically triggering a follow-up action includes:
sending a notification to an employer of the participant's transaction status.

13. The method of claim 2, wherein the sending a notification further includes allowing the participant to electronically repay the funds and replenishing the participant's accounts in the amount of the repayment.

14. The method of claim 13, wherein the allowing the participant to electronically repay the funds includes:
providing a hyperlink in the notification, wherein the participant link to the hyperlink and make the electronic repayment.

15. The method of claim 1, wherein the method further includes:
assigning an eligibility code, if the e-claim is determined to be an eligible claim.

16. The method of claim 1, wherein the method further includes:
providing a claim history report for e-claims made by the participant.

17. The method of claim 1, wherein the receiving a receipt includes receiving a receipt without a matching e-claim.

18. The method of claim 17, wherein the method further includes monitoring for the e-claim to match the receipt.

19. The method of claim 18, wherein the method further includes matching the receipt with the detected e-claim.

20. The method of claim 2, wherein the sending a notification includes sending a letter to the participant.

21. The method of claim 1, wherein the automatically detecting includes detecting a debit in an account balance.

22. The method of claim 1, wherein the method further includes receiving one or more approved real time manual transactions and adjusting an account balance accordingly in real time.

23. The method of claim 1, wherein the method further includes tracking an e-claim made for an unqualified expense and deactivating a debit card associated with the e-claim.

24. The method of claim 1, wherein the method further includes tracking an e-claim made for an unqualified expense and reporting the e-claim to an employer of the participant.

25. The method of claim 1, wherein the method further includes sending additional data about the ineligible claim for an employer to collect through payroll deduction.

26. A method of adjudicating an e-claim made through electronic debit card spending, comprising:
providing a debit card;
automatically detecting an e-claim made by a participant using the debit card;
receiving a receipt for the e-claim;
auditing the e-claim with the receipt to determine whether the e-claim is an eligible claim;
if the e-claim is not an eligible e-claim,
assigning a reason code to the e-claim;
automatically triggering a follow-up action associated with the reason code to inform the participant of the ineligible e-claim; and
if the e-claim is an eligible claim, approving the e-claim.

27. A method of adjudicating an e-claim made through electronic debit card spending, comprising:
automatically detecting an e-claim made by a participant using a debit card;
automatically notifying a participant, if a receipt associated with the e-claim is not received within a predetermined amount of time; and
automatically deactivating the debit card, if the receipt is not received within a second predetermined amount of time.

28. An electronic flex card adjudication system, comprising:
means for automatically detecting an e-claim made by a participant;
means for receiving a receipt for the e-claim;
means for auditing the e-claim with the receipt to determine whether the e-claim is an eligible claim;
if the e-claim is not an eligible e-claim,
means for assigning a reason code to the e-claim;
means for automatically triggering a follow-up action associated with the reason code to inform the participant of the ineligible e-claim; and
if the e-claim is an eligible claim,
means for approving the e-claim.

29. The electronic flex card adjudication system of claim 28, further including:
an Internet interface that allows participants to view status of the e-claim.

30. A program storage device readable by machine, tangibly embodying a program of instructions executable by the machine to perform method steps of adjudicating an e-claim made through electronic debit card spending, comprising:
automatically detecting an e-claim made by a participant;
receiving a receipt for the e-claim;
auditing the e-claim with the receipt to determine whether the e-claim is an eligible claim;
if the e-claim is not an eligible e-claim,
assigning a reason code to the e-claim;
automatically triggering a follow-up action associated with the reason code to inform the participant of the ineligible e-claim; and
if the e-claim is an eligible claim,
approving the e-claim.

31. A program storage device readable by machine, tangibly embodying a program of instructions executable by the machine to perform method steps of adjudicating an e-claim made through electronic debit card spending, comprising:
automatically detecting an e-claim made by a participant using a debit card;
automatically notifying a participant, if a receipt associated with the e-claim is not received within a predetermined amount of time; and
automatically deactivating the debit card, if the receipt is not received within a second predetermined amount of time.

32. A method of processing transactions involving an account reserved for qualified spending, comprising:
automatically receiving transaction data associated with a purchase to be paid from an account reserved for qualified spending;
determining whether the purchase is a qualified transaction for which payment can be made from the account; and
requesting a refund if it is determined that the purchase is not a qualified transaction.

33. The method of claim 32, further including:
sending a request for a receipt associated with the purchase, if the receipt has not been received; and
the step of determining includes verifying whether the purchase is a qualified transaction by auditing the receipt if the receipt is received.

34. The method of claim 32, further including:
requesting for the receipt periodically until the receipt is received.

35. The method of claim 32, further including:
requesting for the refund periodically until the refund is received.

36. The method of claim 32, further including:
allowing a user to connect to a web site for making a refund.

37. The method of claim 36, wherein the allowing includes sending a URL request for a website through which the user can make a refund.

38. The method of claim 32, further including:
receiving an amount of adjustment in an account made due to a manual payment; and
updating an account balance by the amount.

39. The method of claim 32, further including:
transmitting an amount of adjustment made due to direct payment from the account, wherein an entity processing manual payments receives the amount and updates an account balance by the amount.

40. The method of claim 32, further including:
blocking the account if the receipt is not received within a predetermined amount of time.

41. The method of claim 32, further including:
blocking the account if the refund is not received within a predetermined amount of time.

42. The method of claim 32, wherein the purchase is made by using an electronic card issued to a participant.

43. A program storage device readable by machine, tangibly embodying a program of instructions executable by the machine to perform method steps of processing transactions involving an account reserved for qualified spending, comprising:
automatically receiving transaction data associated with a purchase to be paid from an account reserved for qualified spending;
determining whether the purchase is a qualified transaction for which payment can be made from the account; and
requesting a refund if it is determined that the purchase is not a qualified transaction.

44. The program storage device of claim 43, further including:
sending a request for a receipt associated with the purchase, if the receipt has not been received; and
the step of determining includes verifying whether the purchase is a qualified transaction by auditing the receipt if the receipt is received.

45. The program storage device of claim 43, further including:
transmitting an amount of adjustment made due to direct payment from the account, wherein an entity processing manual payments receives the amount and updates an account balance by the amount.

46. The program storage device of claim 43, further including:
receiving an amount of adjustment in an account made as a result of a manual payment; and
updating an account balance by the amount.

47. A system for processing transactions involving an account reserved for qualified spending, comprising:
a module in response to receiving transaction data associated with a purchase for which a payment is to be made from an account reserved for qualified spending, operable to determine whether the purchase is a qualified purchase, and it is determined that the purchase is not a qualified purchase, the module being operable to request a refund for the payment made from the account.

48. The system of claim 47, wherein the module is further operable to connect to a website for allowing a user to make a refund.
